(19) United States
(12) Patent Application Publication
(10) Pub. No.: US 2010/0095041 A1
(43) Pub. Date: Apr. 15, 2010

(54) Multimedia Mobile Device Station and Charger with Built In Accessories

(75) Inventor: William Bailey, Lithonia, GA (US)

Correspondence Address: AT&T Legal Department - Moazzam;Attn: Patent Docketing, Room 2A-207, One AT&T Way, Bedminster, NJ, 07921, US

(73) Assignee: AT & T Delaware Intellectual Property Inc., Wilmington, DE (US)

(21) Appl. No.: 12/251,280

(22) Filed: Oct. 14, 2008

(51) Int. Cl. G06F 13/00

(52) U.S. Cl. 710/303

(57) ABSTRACT

A docking station for a multimedia mobile device. The docking station may include a mobile device interface configured for coupling with a mobile device, the mobile device interface including contact for accessing the mobile device, a user interface for providing inputs to the docking station, a storage device for storing programs and data thereon, and a processor, coupled to the storage device and the mobile device interface, the processor being configured for processing files to be provisioned on a home device.

### BACKGROUND

Advancements in mobile device technology, such as cell phones, have expanded the limits of the capabilities of such devices far beyond just using the phone to make a wireless mobile call. Now, a user of a mobile device may watch television and videos, access the Internet, edit and email documents, take pictures, record video, and download and listen to music all. However, this miniaturization and consolidation of technology and services has presented a few problems.

First, battery power on a mobile device is very limited. The only alternative for a user is to wait for a mobile device to recharge or to use the device while the device is attached to a cord of a recharger. Another disadvantage involves the viewing screen on mobile device. While improvements have been made in using larger viewing screens, the size of the viewing screen remains a problem for most users of mobile devices. The small size strains the user's eyes and leads to mistyped words, and incorrect services. Furthermore, the small screen size results in less use of the product within the home because the user is more comfortable in viewing and using larger keyboards and monitors located in their homes. In addition, the current size of mobile devices allows only one person at a time to share the enjoyment and services of the device. In a similar manner, such mobile devices facilitate games that can only be played by a single party using the device.

It is with respect to these and other considerations that the present invention has been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are described for providing a docking station for a multimedia mobile device. In an embodiment of the present invention, the docking station includes a mobile device interface configured for coupling with a mobile device, the mobile device interface including contact for accessing the mobile device, a user interface for providing inputs to the docking station, a storage device for storing programs and data thereon, and a processor, coupled to the storage device and the mobile device interface, the processor being configured for processing files to be provisioned on a home device.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 illustrates a docking station that only provides audio content;

FIG. 2 illustrates a mobile device according to an embodiment of the present invention;

FIG. 3 illustrates a system for providing a multimedia mobile device docking station and charger with built in accessories according to an embodiment of the present invention;

FIG. 4 is a flow chart of a method for providing multimedia mobile device docking station and charger with built in accessories according to an embodiment of the present invention; and

FIG. 5 is a block diagram of another embodiment of the present invention.

### DETAILED DESCRIPTION

According to an embodiment of the present invention, an interface system for a mobile device is developed to provide new applications and experiences on the mobile device. By providing appropriate interfaces and interconnection with different devices, a mobile device, such as a mobile phone or smart phone, may act as the primary source for household information and entertainment.

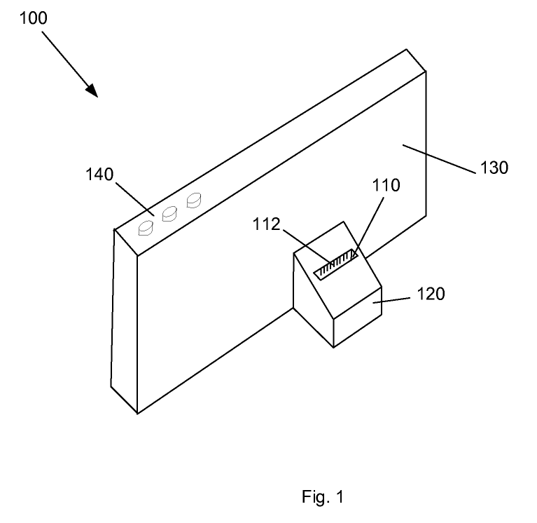

FIG. 1 illustrates a docking station 100 that only provides audio content. A user inserts an audio device, such as a MP3 player, iPod, etc., into a slot 110 in the docking device 120. The docking device 120 includes an interface 112 for accessing files on the audio device. The docking device 120 then processes the audio files for playing the audio files on speakers 130 integrated with the docking station 100. However, additional functionality is not provided. Controls 140 are provided to allow the user to select a volume, station, song, tone, etc.

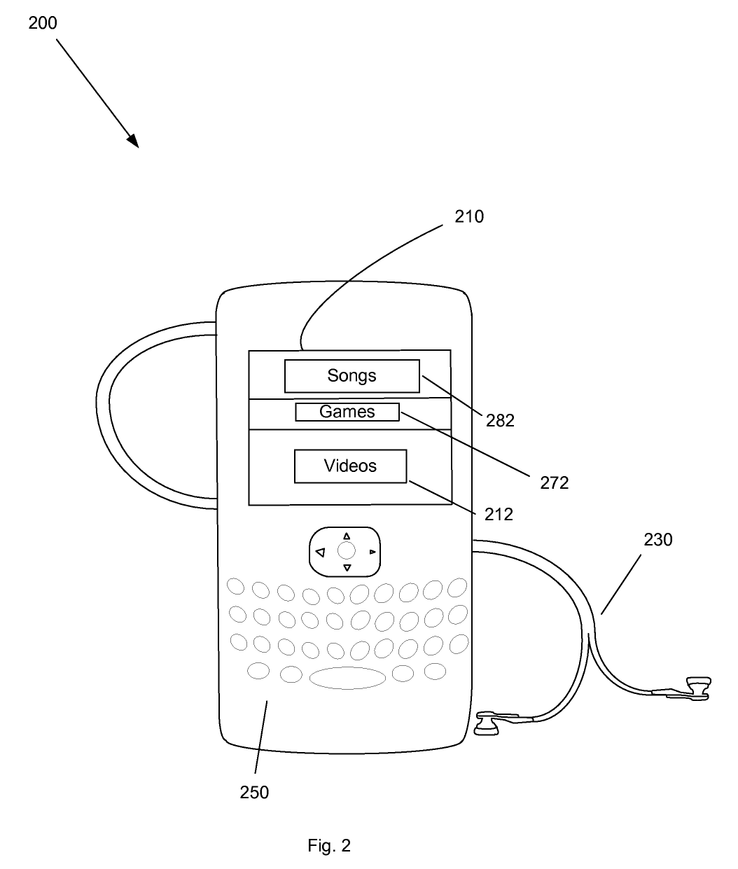

FIG. 2 illustrates a mobile device 200 according to an embodiment of the present invention. The mobile device 200 includes a display screen 210. The display screen 210 may be used to present video 212 to a user. The display screen 210 may also be used to select games 272 and audio files or songs 282. A user typically uses earphones or earbuds 230 to listen to the audio files 282 being played on the mobile device 200. The mobile device 200 may also function as a mobile phone. A keypad 250 is provided for allowing a user to send messages and to dial phone number to call. However, once a user returns home, the user typically will stop using the mobile device 200. Instead, the user will transition to use of a component music system, a television, or a computer for receiving information or entertainment content.

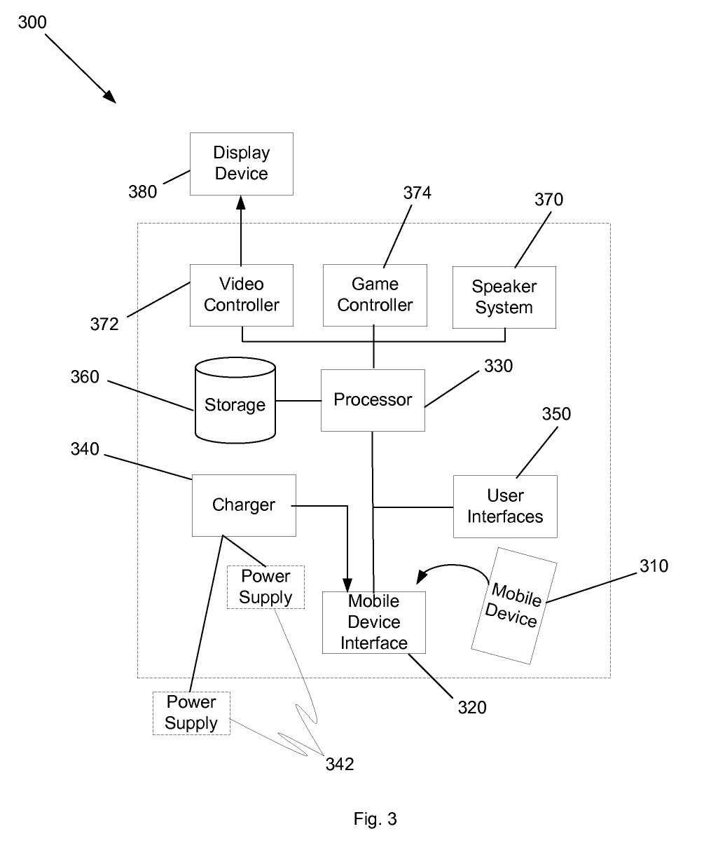

FIG. 3 illustrates a system 300 for providing a multimedia mobile device docking station and charger with built in accessories according to an embodiment of the present invention. In FIG. 3, a mobile device 310 is coupled to a mobile device interface 320. The mobile device interface 320 provides accessibility to files and functions of the mobile device 310. A processor 330 is coupled to the mobile device interface 320. A charger 340 is also coupled to the mobile device interface 320. The charger 340 may be used to provide recharging to the mobile device 310. Power to the multi-media docking station for operating the docking station and recharging the docked multi-media device is supplied by a power supply 342. The power supply 342 may be an internal or external power supply 342. The power supply 342 may be configured to supply power by being plugged into an electrical outlet.

Various user interfaces 350 are coupled to the mobile device interface 320 and the processor 330. The user interface 350 may be a keyboard for data entry, a joystick, trackball or mouse for providing navigation and selection functions, a game controller for providing gaming commands and functions, a remote control device for providing remote control to associated electronic equipment; etc. Those skilled in the art will recognize that this list is not meant to be limiting, but rather is provided for illustration of a few embodiments of the present invention.

Software and data files that the processor 330 accesses may be stored on the non-volatile storage device 360. The processor 330 may provide signals to a speaker system 370, a video controller 372 and a game controller 374. Other devices may also be coupled to the processor 330 for provisioning of additional functions.

A display device 380 may be coupled to the video controller 372. The display device 380 may be a part of the system or may be separate from the system. Moreover, the display device 380 may be a television, a projector, or any other type of display device. The system 300 prevents customers from being tied down at home to watch television, listen to music, use the telephone, or surf the net. The system 300 provides all of these abilities while utilizing only one device.

The system 300 provides an avenue that allows users to disconnect from home cable companies, wireline telecommunication providers, and Internet for a desktop or home based personal computers. At the same time, however, the system 300 offers users the convenience and familiarity of large home products while the user is home, and allows the user freedom to leave at any time without disruption to the activity the user was engaged in at home. In addition, the system 300 provides an incentive to a user to consolidate all their services with one provider to reduce costs. Thus, users will slowly start to disconnect services that they would normally use at home, e.g., cable TV, radio, desktop personal computer, home landline phone, etc., and substitute all of these services for the ones they receive under one price plan on a mobile device 310.

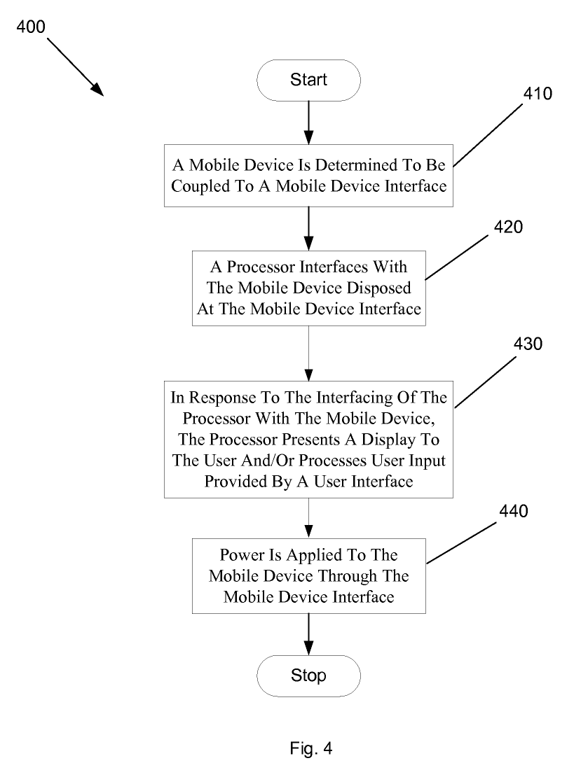

FIG. 4 is a flow chart 400 of a method for providing multimedia mobile device docking station and charger with built in accessories according to an embodiment of the present invention. In FIG. 4, a mobile device is determined to be coupled to a mobile device interface 410. A processor interfaces with the mobile device disposed at the mobile device interface 420. In response to the interfacing of the processor with the mobile device, the processor presents a display to the user and/or processes user input provided by a user interface 430. Power is applied to the mobile device through the mobile device interface 440.

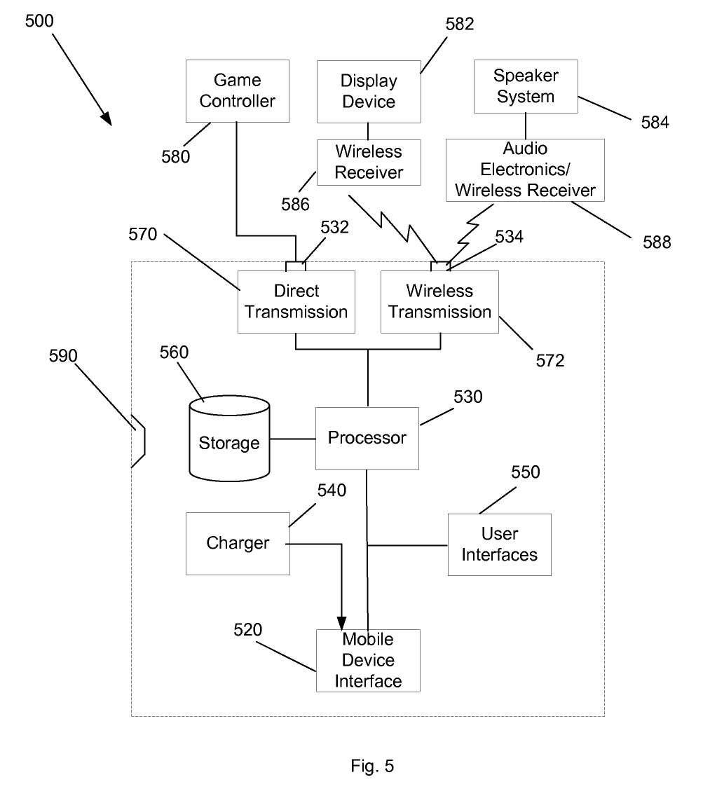

FIG. 5 is a block diagram 500 of another embodiment of the present invention. In FIG. 5, a mobile device interface 520 and charger 540 may be provided as was shown with reference to FIG. 3. A processor 530 is coupled to the mobile device interface 520. However, in FIG. 5, the processor 530 is coupled to ports 532, 534 through various circuits 570, 572 to provide signals either directly or wirelessly to different devices 580, 582, 584 in the house. For example, game controller 580 receives a hard-wired signal from the direct transmission circuit 570 from the processor 530. The display device 582 and the speaker system receive wireless signals that are received by wireless receiver 586 and audio electronics/wireless receiver 588. The user may control what signals are being sent to which device. Software and data files that the processor 530 accesses may be stored on the non-volatile storage device 560.

Those skilled in the art will readily recognize that the arrangement shown in FIG. 5 is not meant to be limiting. Rather, the system is configured to allow a user complete flexibility in selecting the arrangement of devices for receiving signals from the system. Moreover, the storage device 560 may be accessed by a user through the mobile device or through a configuration port 590, e.g., a USB port, to allow the user to download files and software, to configure the software processed by the processor 530 and to control how the user enjoys the experience provided through the mobile device. Again various user interfaces 550 may be coupled to the mobile device interface 520 and the processor 530 to navigate and provide input to the system.

Although the invention has been described in connection with various embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A docking station for a multimedia mobile device, comprising:
a mobile device interface configured for coupling with a mobile device, the mobile device interface including contact for accessing the mobile device;
a user interface for providing inputs to the docking station;
a storage device for storing programs and data thereon; and
a processor, coupled to the storage device and the mobile device interface, the processor being configured for processing files to be provisioned on a home device.

2. The docking station of claim 1, wherein the home device is a television.

3. The docking station of claim 1, wherein the home device is audio equipment including an amplifier and speakers, wherein the speakers are disposed remotely from the docking station.

4. The docking station of claim 1, wherein the home device is a gaming console.

5. The docking station of claim 1, wherein the processor accesses audio files on the mobile device and routes audio signals through a house to remotely located audio equipment and speakers.

6. The docking station of claim 1, wherein the processor accesses downloaded video from the mobile device and presents the video on a remote display device.

7. The docking station of claim 6, wherein the remote display device comprises a home theater system.

8. The docking station of claim 6, wherein the remote display device comprises a projector system.

9. The docking station of claim 6, wherein the remote display device comprises a television.

10. The docking station of claim 1, wherein the processor accepts inputs from a plurality of users to enable multiplayer gaming.

11. The docking station of claim 1 further comprising a charger for providing a power signal to the mobile device interface for recharging the mobile device.

12. The docking station of claim 1 further comprising a wireless transmitter, the processor providing signals to the wireless transmitter for wireless transmission to a remote home device having a wireless receiver configured for reception of the wireless transmission.

13. The docking station of claim 12, wherein the signals provided to the wireless transmitter for wireless transmission comprises wireless display signals.

14. The docking station of claim 12, wherein the signals provided to the wireless transmitter for wireless transmission comprises wireless audio signals.

15. A method for providing multimedia mobile device docking, comprising:
determining when a mobile device is coupled to a mobile device interface;
coupling a processor to a mobile device for interfacing with the mobile device disposed at the mobile device interface;
in response to the interfacing of the processor with the mobile device, presenting a display to the user; and
applying a power signal to the mobile device through the mobile device interface for recharging the mobile device.

16. The method of claim 15, wherein user input provided by a user interface is processed in response to the interfacing of the processor with the mobile device.

17. The method of claim 15 further comprising accesses audio files on the mobile device and routing audio signals through a house to remotely located audio equipment and speakers.

18. The method of claim 15 further comprising accessing downloaded video from the mobile device and presenting the video on a remote display device.

19. The method of claim 15 further comprising accepting inputs from a plurality of users to enable multiplayer gaming.

20. The method of claim 15 further comprises providing signals to a wireless transmitter for wireless transmission to a remote home device having a wireless receiver configured for reception of the wireless transmission.
